(19) United States
(12) Patent Application Publication
(10) Pub. No.: US 2009/0170457 A1
(43) Pub. Date: Jul. 2, 2009

(54) Satellite Radio Recorder Predictive Buffering

(75) Inventor: Matthew C. Videtich, Farmington Hills, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: General Motors Corporation, Detriot, MI (US)

(21) Appl. No.: 11/967,996

(22) Filed: Dec. 31, 2007

(51) Int. Cl. H04B 1/18

(52) U.S. Cl. 455/185.1

(57) ABSTRACT

Aspects of the invention buffer user preferred radio content on a radio system by monitoring the content on multiple channels in case a user desires to record one of the monitored channels. The content on the monitored channels is buffered from the start of the radio content (i.e. song, talk show, program etc.) playing on each channel. For example, aspects of the invention allow a user to record a song playing on another channel in its entirety if the user switches channels and hears a song that the user would like to record but is in the middle of the song.

### TECHNICAL FIELD

This application relates generally to manipulation of entertainment content, and more particularly to the monitoring and recording of entertainment content.

### BACKGROUND OF THE INVENTION

Automobile network solutions are one of the fastest growing areas of communications technology. As an increasing number of cars incorporate some level of telematics service, the number of telematics service choices has also expanded.

For example, currently available telematics services include, but are not limited to, turn-by-turn directions and other navigation-related services provided in conjunction with the GPS based chipsets and components, airbag deployment notification and other emergency or roadside assistance-related services provided in connection with various crash and/or collision sensor interface modules and sensors located throughout the vehicle. Telematics services also include entertainment services wherein music, Web pages, movies, television programs, video games or other content is downloaded by an entertainment center operatively connected to the telematics unit.

However, the increasing number of services and segments within services makes it difficult for the user to choose between entertainment options. This is especially true in environments involving broadcast content, as distinguished from individually directed content. For example, within a broadcast satellite radio system service, a user may find that they have missed portion of a song or program of interest while listening to another song or program of interest. In this case, while the user may experience the remainder of the new song or program, they are unable to enjoy the portion already broadcast before the user tuned in.

### BRIEF SUMMARY OF THE INVENTION

Aspects of the invention facilitate the buffering of user preferred radio content on a radio system by monitoring the content on multiple channels for an indication that a user desires to record one of the monitored channels. The content on the monitored channels is buffered from the start of a unit of radio content (i.e. song, talk show, program etc.) playing on each channel. For example, aspects of the invention allow a user to record a song playing on a channel in its entirety if the user switches to that channel part way through the song. Other aspects and features of various implementations will be appreciated from the following description.

### BRIEF DESCRIPTION OF THE SEVERAL VIEWS OF THE DRAWINGS

FIG. 1 is a schematic view of a communication system within which examples of the disclosed system may be implemented;

FIG. 2 is a general architecture overview of selected aspects of the invention in keeping with the disclosed principles;

FIG. 3 is a flow diagram that illustrates a process of monitoring and recording an item of radio content in accordance with the disclosed principles; and

FIG. 4 is a general architectural overview of a telematics unit and operational environment in keeping with the disclosed principles.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

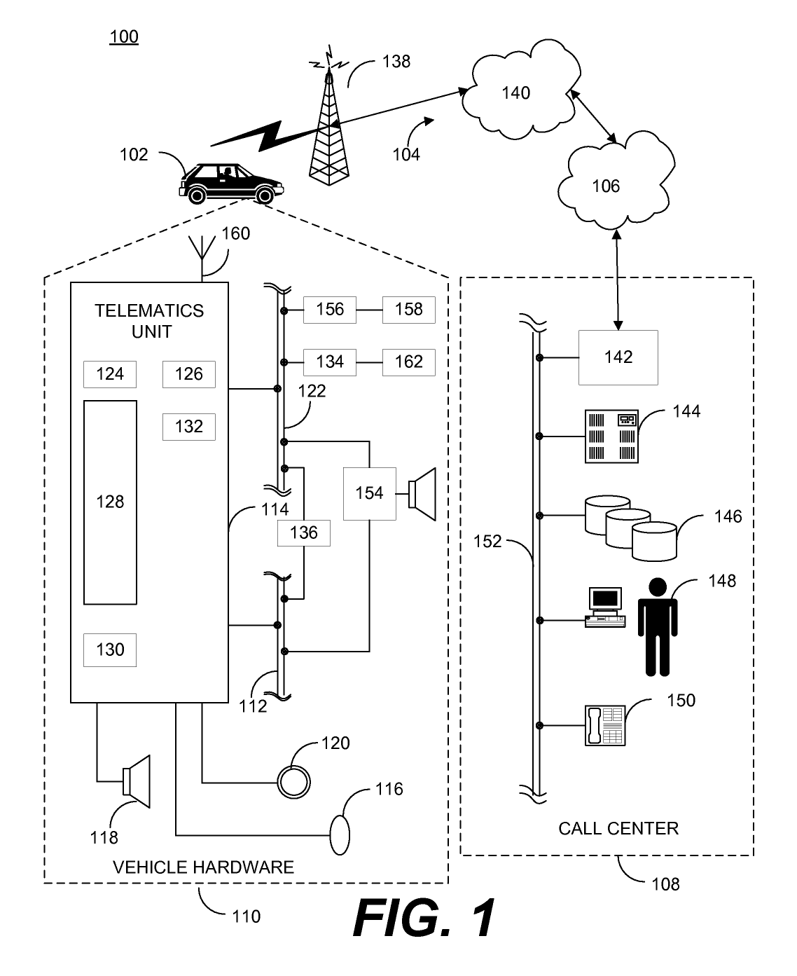

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

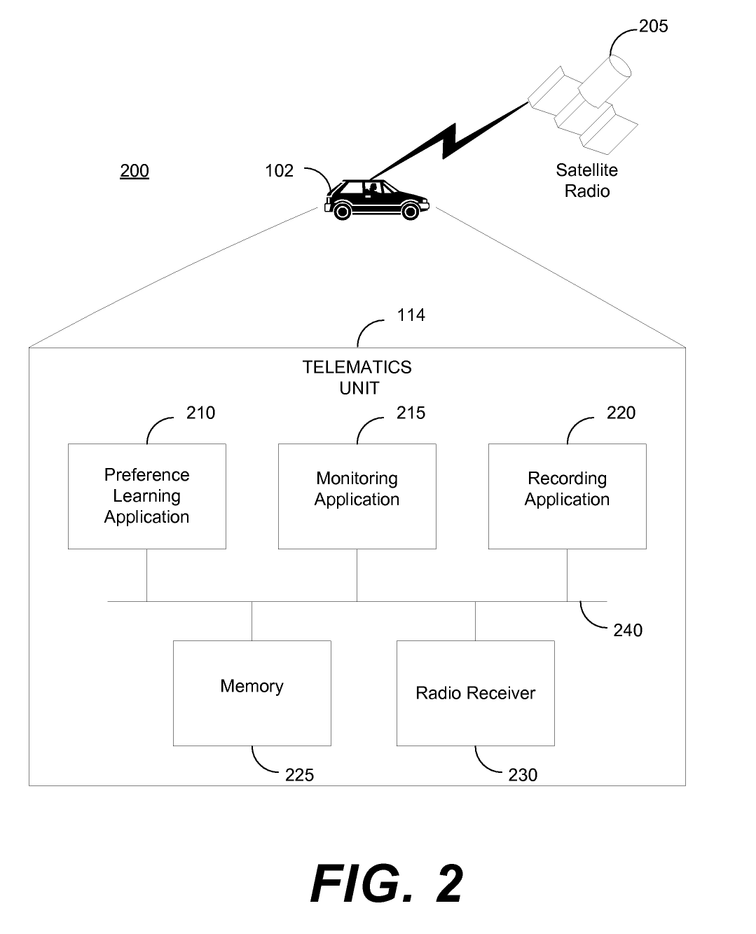

FIG. 2 is a general architecture overview 200 of selected aspects of the invention in keeping with the disclosed principles. In the illustrated system 200, a radio receiver 230 in the telematics equipped vehicle is operable to receive satellite radio channels 205. Note that the invention is not limited to receiving satellite radio signals but also pertains to the receipt and processing of other media bearing radio or other content. Further, in other aspects of the invention, the radio receiver may be separate from the telematics unit. A telematics unit 114 within the vehicle may contain one or more software applications to implement aspects of the invention that include, but are not limited to, user preference learning, radio channel monitoring, and radio channel recording. Software applications may communicate with each other, a radio receiver, and/or computer-readable memory (where the memory may be within the telematics unit or within the radio receiver) using mechanisms (i.e. internal bus) 240 known to those skilled in the art.

In overview, a preference learning software application 210 is operable to observe user actions and learn user preferences for radio channels and radio content. The preference learning software application 210 then builds a user preference list that identifies radio stations for which the user has shown a preference. Preferences may change over time and, the identification of preferences may be based on a weighted Gaussian estimate or other more simple or more complex techniques. In one implementation, the user preference list is based on the frequency and time window of use, i.e., the list may identify all stations listened to for at least x minutes in the past y days, etc.

A monitoring software application 215 monitors the radio channels contained in the user preference list. When a user listens to radio content from a first radio channel, a recording software application 220 may record or buffer radio content (i.e. songs, talk shows, news programs, etc.) on one or more other radio channels identified in the user preference list. This may occur whether or not the first channel is on the user preference list. Further, a recording software application is operable to store the buffered radio content into the telematics unit's memory, a radio receiver's memory, or transmit the radio content to a telematics service provider center for storage in a user profile database for further access.

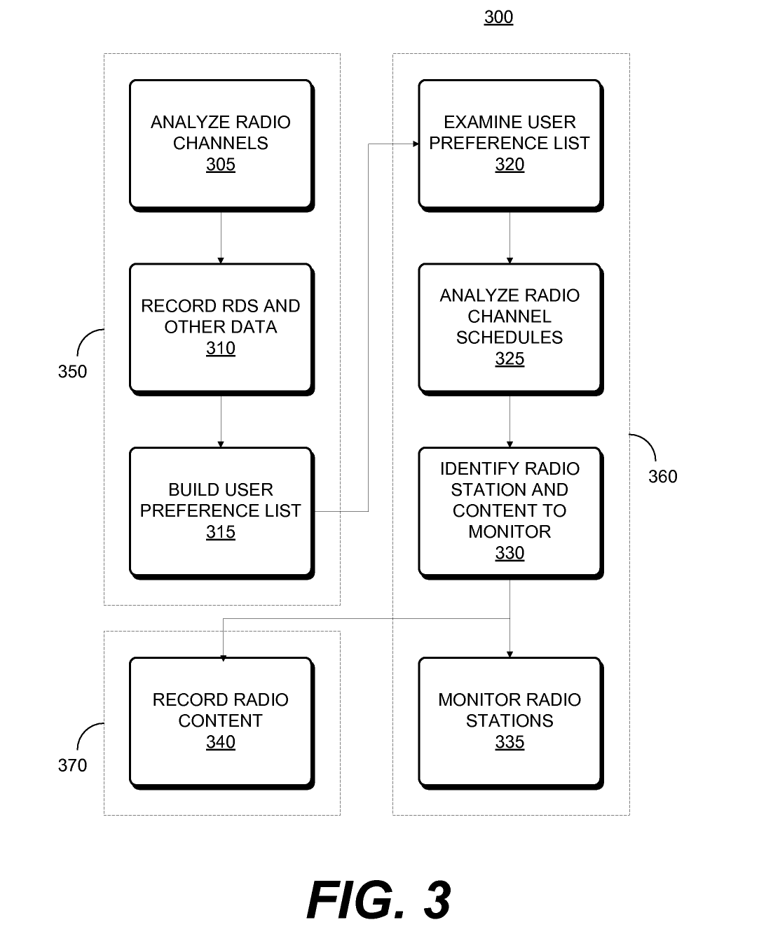

FIG. 3 is a flow diagram 300 that illustrates a process of monitoring and recording an item of radio content in accordance with the disclosed principles. Groups of stages shown in FIG. 3 may implement aspects of the invention that include a user preference learning function, radio channel monitoring function, and a radio channel recording function. These functions may be implemented by software applications depicted in FIG. 2.

The stages within group 350 may be described as performing the preference learning function, while the stages within group 360 may be described as implementing the monitoring function. Stage 370 describes the recording of radio content. The detailed steps for implementing the functions depicted in FIG. 3 are as follows. At stage 305, a preference learning software application 210 analyzes data for channels that are selected by a user while listening to the radio. This is preferably a step that occurs in real time, although it is also possible to log such data, e.g., for periodic analysis. Subsequently at stage 310, the preference learning software application 210 records the Radio Data System (RDS) information or other identifying data such as the program type, station call letters, station identification numbers, name of the song, talk show, news program, talk show host, etc. with respect to the channels selected by the user.

At a next stage 315, a software preference learning application 210 builds a user preference list based on analysis of the user's radio listening habits. For example, the preference learning application 210 may learn at stage 315 that a user alternates in listening to four different jazz stations. The preference learning function may use, for example, the RDS and identification information of the relevant channels to determine that they are playing jazz music. The preference learning function may then incorporate the radio stations into the user preference list.

At a next stage 320, the monitoring software application 215 examines the user preference list. Subsequently at stage 325, the monitoring software application 215 analyzes the radio channel schedules it learns during the preference learning stage 350, e.g., it reads the preference list and notes the identities of the stations of interest. At stage 330, the monitoring software application 215 identifies other radio channels and radio content to monitor while the user is listening to a first radio station/channel.

At a next stage 335, e.g., while the radio system is on, the monitoring software application 215 monitors radio stations/channels other than the one being listened to by the user, based on the user preference list. At a next stage 340, the recording software application 220 records the radio content for later playback to the user. In an example of the monitoring function 360 and recording function 370, if a user prefers jazz, and there are four jazz radio stations available each playing a song, the four jazz stations may be placed on the user preference list during the preference learning stage 350. Consequently, each of the four jazz radio stations is monitored and each song is buffered when they each first start playing. This allows a user to record a song playing on another channel in its entirety if the user switches channels and hears a song that the user would like to record but is in the middle of the song. The buffering of items of content, e.g., individual songs, individual programs, etc., may extend for only one item, with the next item overwriting the previous item, or the buffering may extend for a predefined number of items, units of time, etc.

The recording function may be enabled automatically, such as by setting a preference initially, or it may be activated by a voice command, control input button on a telematics unit or by a button on a radio receiver. Content may be stored in a radio receiver, telematics unit, or combination of both to maximize in-vehicle memory utilization. Alternatively or additionally, the content may be cached inn an in-vehicle memory device and then transferred to the call center for storage in a user profile database for further access.

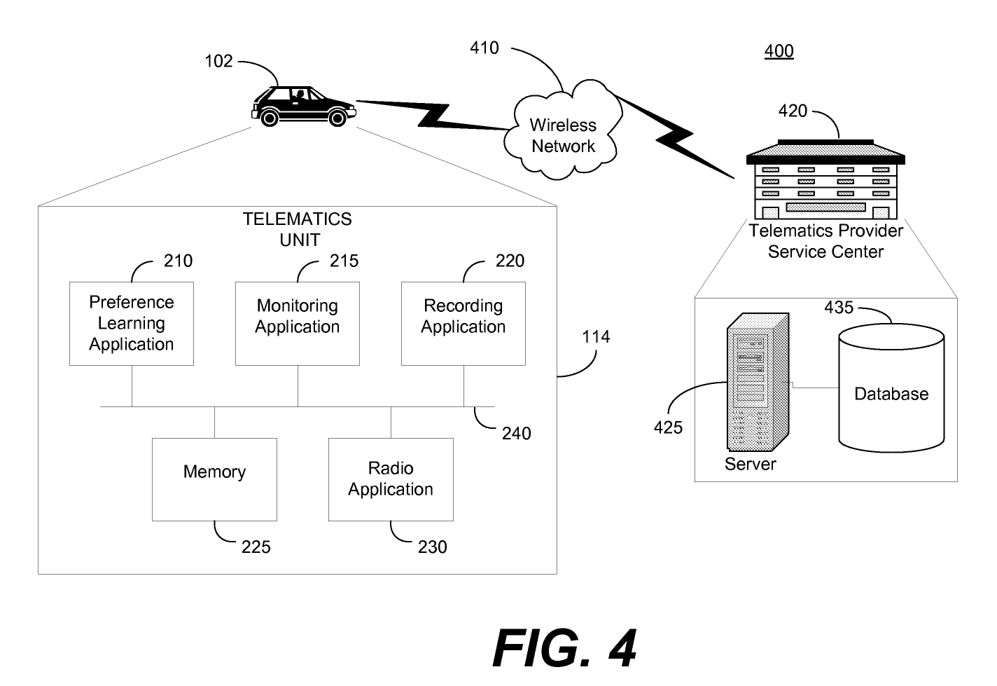

FIG. 4 is a general architectural overview of a telematics unit and operational environment in keeping with the disclosed principles. The recording software application 220 may transmit buffered radio content to a telematics service provider service center 420 across a wireless network 410. A server 425 at the service center 420 stores the buffered radio content in one or more user profile databases 435 for later access.

The recorded content may be played automatically when the user switches to the station from whence the content was recorded, or the user may be presented with a list of recorded content. In this configuration, the list is preferably updated when the recorded content changes, e.g., when a previous item of content is overwritten by a subsequent item. The user may select an item to play either by selecting it from the list via a cursor, scroll key, etc., switching to the channel associated with an item, or via a voice command such as “play item 4.” In this manner, although a user may not be tuned to a particular station at the moment that an item of interest begins playing, the user is able to selectively experience the entirety of an item if a portion of that item piques the user's interest. Although it is possible to record all channels rather than identifying user preferences, it will be appreciated that this approach requires significantly greater memory and processing resources.

It will be appreciated that a new and useful system for content selection and management has been described. All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred configurations of this invention are described herein, including the best mode known to the inventors for carrying out the invention. Variations of those preferred configurations will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for predictive buffering of radio content, the method comprising:
learning user channel and content preferences based on observation of radio listening habits of a radio user, whereby a user channel preference list is created identifying a plurality of user-preferred channels;
monitoring one or more of the user-preferred channels, where a user is currently listening to radio content on a first radio channel that is not one of the one or more user-preferred channels being monitored; and
recording in a computer-readable memory an item of content from each of the monitored channels while the user continues to listen to the first channel.

2. The method according to claim 1, further comprising:
analyzing radio channels listened to by the user;
recording RDS data and identification data from each radio channel listened to by the user; and
building a user preference list using the RDS data and identification data.

3. The method according to claim 1, further comprising:
examining a user preference list to determine monitoring a plurality of radio channels other than a first radio channel where a user is currently listening to radio content on the first radio channel;
analyzing radio channel schedules, to determine monitoring a plurality of radio channels other than a first radio channel, where a user is currently listening to radio content on the first radio channel; and
identifying user preferred radio channels and radio content to monitor a plurality of radio channels other than a first radio channel, where a user is currently listening to radio content on the first radio channel.

4. The method according to claim 1, wherein the computer-readable memory is selected from the group consisting of a radio receiver memory, a telematics unit memory, and a database.

5. The method according to claim 2, wherein identification data is selected from the group consisting of program type, radio station call letter, radio station identification numbers, song name, talk show name, program name, musical artist, talk show host, and program author.

6. The method according to claim 1, further comprising presenting a user interface whereby the user can make a selection of one of the recorded items of radio content.

7. A system for predictive buffering of radio content, the system comprising:
a telematics unit having associated therewith a radio receiver capable of downloading radio content;
a preference learning module to learn user channel preferences;
a preference learning module to monitor radio transmissions in keeping with the user channel preferences; and
a recording module to record a plurality of items of radio content from the monitored radio transmissions.

8. The system according to claim 7, further comprising:
a wireless network that provides communication between the telematics unit and a telematics provider service center;
a server that implements recording functions that records radio content from a telematics unit into a database; and
a database that stores radio content according to a user profile for later access by the user.

9. The system according to claim 7, wherein the preference learning software application learns user preferences based on the radio listening habits of a radio user.

10. The system according to claim 7, wherein the monitoring software application monitors a plurality of radio channels, other than a first radio channel, where a user is currently listening to radio content on the first radio channel.

11. The system according to claim 7, wherein the recording software application records content from a plurality of monitored radio channels other than a first radio channel into memory, where a user is currently listening to radio content on the first radio channel.

12. The system according to claim 7, wherein the preference learning software application executes steps comprising:
analyzing the radio channels listened to by the user;
recording RDS data and identification data from the radio channels listened to by the user; and
building a user preference list based on the recorded RDS data and identification data.

13. The system according to claim 7, wherein the monitoring software application executes steps comprising:
examining a user preference list and radio channel schedules; and
identifying user preferred radio channels based on the user preference list to monitor a plurality of preferred radio channels other than a first radio channel, wherein the user is currently listening to radio content on the first radio channel.

14. The system according to claim 7, further comprising a user interface for receiving a user selection of one of the recorded items of radio content

15. The system according to claim 14, wherein the memory is selected from the group consisting of a radio receiver memory, a telematics unit memory, and a database.

16. The system according to claim 12, wherein the identification data is selected from the group consisting of program type, radio station call letter, radio station identification numbers, song name, talk show name, program name, musical artist, talk show host, and program author.

17. The system according to claim 8, wherein the wireless network is selected from the group consisting of wireless wide area networks, wireless metropolitan area networks, wireless local area networks, CDMA2000, Evolution Data Optimized (EVDO), High Speed Downlink Packet Access (HSDPA), GSM, WiFi, and WiMAX networks.

18. A method of managing content for a user of a radio associated with a telematics unit, the method comprising:
observing user listening habits displayed by the user while listing to the radio;
creating a user content preference list based on the observed listening habits;
monitoring a plurality of stations to identify the occurrence of a first item of radio content consistent with the user content preference list; and
recording the first item of radio content while the user is listening to radio content other than the first item of radio content.

19. The method according to claim 18, wherein creating a user content preference list based on the observed listening habits comprises listing content or stations listened to by the user for a predetermined amount of time with a predetermined interval.

20. The method according to claim 18, further comprising receiving a user selection of the first item of radio content and playing the first item of radio content responsive to the user selection.
